(19) United States
(12) Patent Application Publication
(10) Pub. No.: US 2011/0197202 A1
(43) Pub. Date: Aug. 11, 2011

(54) Handling Messages in a Computing Device

(75) Inventor: Francesco Lodolo, London (GB)

(73) Assignee: Nokia Corporation, Espoo (FI)

(21) Appl. No.: 13/001,012

(22) PCT Filed: Jun. 24, 2009
(86) PCT No.: PCT/IB2009/006032

§ 371 Date: Mar. 17, 2011

(30) Foreign Application Priority Data
Jun. 25, 2008 (GB) 0811652.7

(51) Int. Cl. G06F 9/46

(52) U.S. Cl. 719/313

(57) ABSTRACT

A method for determining dynamically how data processing requests are to be handled within a computing device. On receipt of a message at a central dispatching entity, the dispatching entity retrieves information from a database specifying how the message is to be handled, and in response it issues commands to selected components within the computing device to cause a data processing operation to be performed.

This application relates to the handling of messages in computing devices, and in particular to messages relating to data processing operations.

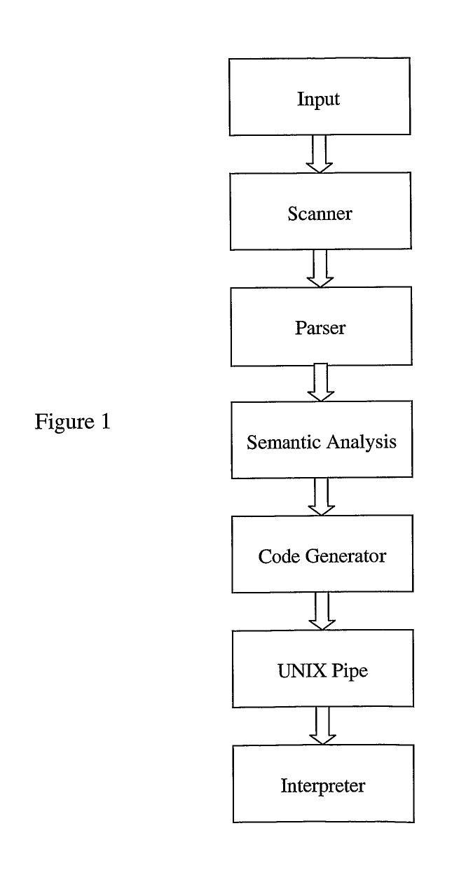

When a computing device is required to perform a task for a user, instructions are passed internally within the computing device in order to initiate the appropriate processing elements within the device to perform the task. Architectural patterns are known which split a task of a system into several smaller processing steps, which are connected by the data that flows through the steps. Such a pattern is called a “pipes and filters” pattern: each “filter” implements a processing step, and a “pipe” connects the steps by enabling data to flow between them. An example of a task represented according to the pipes and filters pattern is provided in FIG. 1. This shows various processing steps associated with a file of text data.

Another construct for representing data processing operations is exemplified in the OpenMAX IL standard 1.1.1 developed by the Khronos Group. This standard defines an application programming interface (API) for multimedia applications that enables software developers to use codecs, libraries and other functions for the processing of video, audio, speech and still image data. The OpenMAX standard includes a definition of a “component” as an individual data operator. Each component is a block of functionality which may be a data source, a data sink, a codec, a filter, a splitter, a mixer, or any other type of operator, and each component may be hardware, software, a processor, or a combination of these. Data to be processed for a particular use case is passed sequentially through a series of components in order for a desired result to be attained.

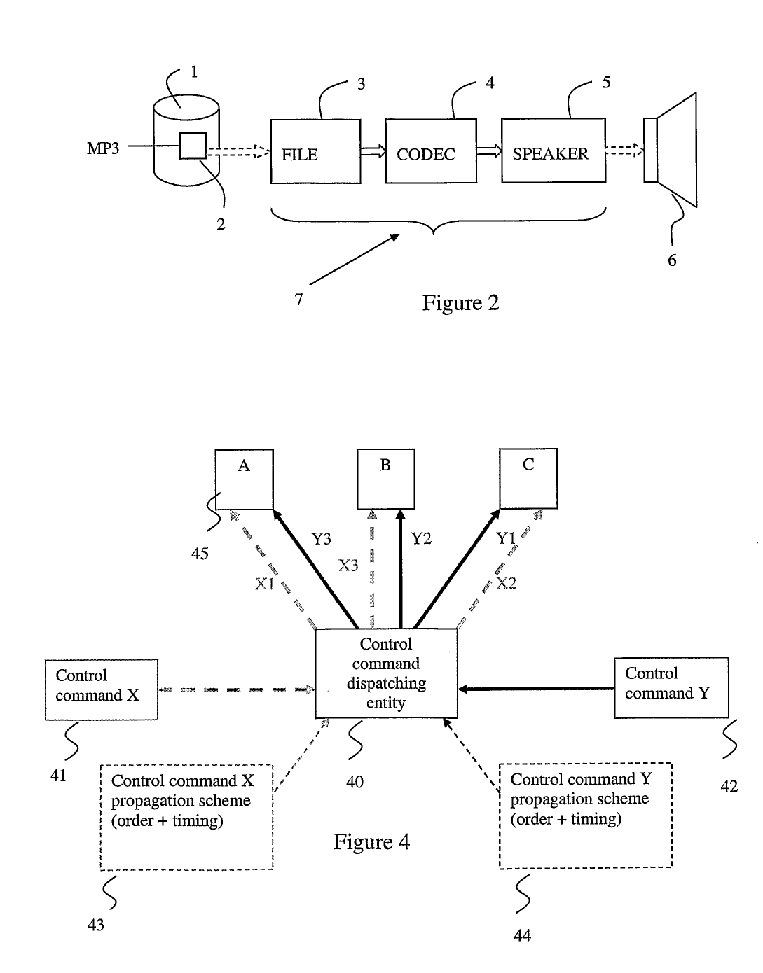

In existing computing devices, a common way of providing for specific data processing requirements is by identifying a series of expected use cases, writing customised software for achieving the required data processing steps associated with each individual use case, and storing that software on a computing device in such a way that it is available to be used when the corresponding use case is detected within the computing device. The term “hardcoded” may be used to refer to such instances of permanently stored computer programs intended to deal with specific anticipated use cases. For example, in a particular use case involving audio data processing it might be necessary to (i) retrieve MP3-format audio data from a file on a computing device, (ii) decode the stored audio data in accordance with an MP3 codec, and (iii) provide the decoded data to a speaker on the device for playing out the sound to a user. This example is illustrated in FIG. 2 by way of a series of blocks representing different components. In FIG. 2 a data storage medium 1 contains an MP3 audio file 2. The file is identified, in component 3, as the data source within the series of data processing components. The file is fetched from its location in storage 1, and then passed to a codec 4 which decodes the MP3 data before it is passed on to a data sink 5 which in this example is a speaker 6. The components 3-5 and the relationships between them are predefined and stored, such that they are available to be called upon whenever an MP3 file is to be played out on the computing device.

In accordance with a first example of the present invention there is provided a method for handling messages relating to data processing operations in a computing device, the method comprising: receiving a message from a client process at a dispatching entity; in response to receiving the said message, retrieving, from an entity external to the dispatching entity, data specifying how the message is to be handled; and in response to retrieving the said data, causing one or more selected components of the computing device to carry out a data processing operation indicated in the message, by sending further messages from the dispatching entity to the said components.

The data specifying how the message is to be handled may specify control operations, which may involve, for example, the selection, set-up, binding, state changes, or timings of components for carrying out the data processing operation. In order to perform the data processing operation indicated in the message, it may be the case that individual components each carry out respective data processing operations of their own, which may contribute to the overall data processing operation.

In accordance with this example, the selected components may be grouped into a stream, or into a stream container, for example, as described below.

The retrieval of data specifying how the message is to be handled may be performed at runtime, such that a determination of how the message is to be processed is made dynamically in response to receiving the said message at the dispatching entity. This can provide for flexibility in the ability of the computing device to respond to messages, since the responses need not be hardcoded in the computing device.

The retrieval of data may comprise retrieving a predefined scheme from a database, the scheme corresponding to the message received at the dispatching entity. This can allow for a low processing overhead and a relatively fast response in processing the message, since the dispatching entity in this instance receives specific instructions on how to handle the message from the client process.

The scheme may specify which components are to be used in the handling of the message. Furthermore, the scheme may additionally specify timing considerations relating to the components that are to be used in the handling of the message, such as the order in which the said further messages are to be sent from the dispatching entity to the said components. This can assist with efficient execution of the data processing operation, since it can ensure that messages are not sent to components before they are ready to respond to them.

The timing considerations may be based on hardware or software dependencies between the said components, or on conditions prevailing within the computing device, or on the physical locations of hardware elements within the device, among other factors. This can ensure that when one component relies on the hardware or software of another component for its operation, this dependency is taken into account when the data processing operation is carried out by messages sent from the dispatching entity. The conditions prevailing in the device may include factors such as which hardware or software features are available, or the current state of certain hardware or software features.

When no predefined scheme exists which corresponds to the message received at the dispatching entity, the retrieval of data may comprise retrieving one or more rules, where a rule may correspond to more than one message and specify how a given type of message is to be handled.

According to a second example of the invention there is provided a dispatching entity for handling messages relating to data processing operations in a computing device, the dispatching entity being arranged to perform: receiving a message from a client process; in response to receiving the message, retrieving, from an entity external to the dispatching entity, data specifying how the message is to be handled; and in response to retrieving the data, causing one or more selected components of the computing device to carry out a data processing operation indicated in the message, by sending further messages to the selected components.

The dispatching entity may be provided as a software product, or as part of a software product, or it may be implemented wholly or partly in hardware.

According to a third example of the invention there is provided apparatus comprising the dispatching entity of the second example.

According to a fourth example of the invention there is provided an operating system comprising the dispatching entity of the second example.

According to a fifth example of the invention there is provided a computer program arranged to perform the method of the first example.

Examples of the invention also provide a computer readable medium and a computer program product storing a computer program for performing the method of the first example.

The invention will now be described by way of example with reference to the accompanying drawings, in which:

FIG. 1 is a representation of a data processing sequence in accordance with the prior art pipes and filters pattern;

FIG. 2 is a representation of a data processing sequence in the context of a multimedia operation;

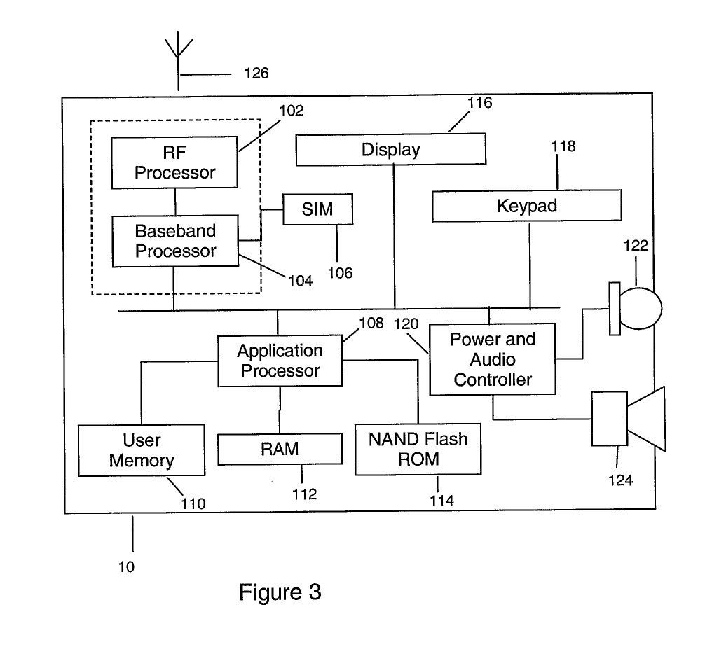

FIG. 3 shows an example of a prior art computing device, which provides a suitable environment for the operation of the present invention;

FIG. 4 is a schematic representation of the propagation and execution of commands in an exemplary computing device; and

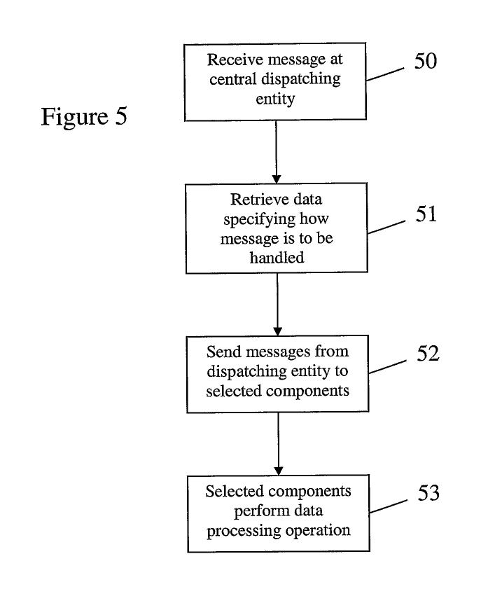

FIG. 5 shows a summary of a process according to an embodiment of the invention.

Many modern electronic devices make use of operating systems. Modern operating systems can be found on anything composed of integrated circuits, like personal computers, Internet servers, cell phones, music players, routers, switches, wireless access points, network storage, game consoles, digital cameras, DVD players, sewing machines, and telescopes. In an example embodiment, an operating system, which may be software manages the sharing of the resources of the device, provides programmers with an interface to access those resources. An operating system processes system data and user input, and responds by allocating and managing tasks and internal system resources as a service to users and programs on the system. At its most basic, the operating system performs tasks such as controlling and allocating memory, prioritising system requests, controlling input and output devices, facilitating networking, and managing files. An operating system is in essence an interface by which higher level applications can access the hardware of the device.

FIG. 3 shows an example of a device that could benefit from the teachings of the present invention: a smartphone 10 comprises hardware to perform telephony functions, together with an application processor and corresponding support hardware to enable the phone to have other functions which are desired by a smartphone, such as messaging, calendar, word processing functions and the like. In FIG. 3 the telephony hardware is represented by the RF processor 102 which provides an RF signal to antenna 126 for the transmission of telephony signals, and the receipt therefrom. Additionally provided is baseband processor 104, which provides signals to and receives signals from the RF Processor 102. The baseband processor 104 also interacts with a subscriber identity module 106, as is well known in the art.

Also typically provided is a display 116, and a keypad 118. These are controlled by an application processor 108. Application processor 108 may be a separate integrated circuit from the baseband processor 104 and RF processor 102. However it is anticipated that single chip solutions will become available. A power and audio controller 120 is provided to supply power from a battery to the telephony subsystem, the application processor, and the other hardware. Additionally, the power and audio controller 120 also controls input from a microphone 122, and audio output via a speaker 124.

In order for the application processor 108 to operate, various different types of memory are often provided. Firstly, the application processor 108 may be provided with some Random Access Memory (RAM) 112 into which data and program code can be written and read from at will. Code placed anywhere in RAM can be executed by the application processor 108 from the RAM.

Additionally provided often is separate user memory 110, which is used to store user data, such as user application programs (typically higher layer application programs which determine the functionality of the device), as well as user data files, and the like.

As mentioned previously, in order for the application processor 108 to operate, an operating system is necessary, which must be started when the smartphone system 10 is first switched on. The operating system code is commonly stored in a Read-Only Memory, and in modern devices, the Read-Only Memory is often NAND Flash ROM 114. The ROM will store the necessary operating system component in order for the device 10 to operate, but other software programs may also be stored, such as application programs, and the like, and in particular those application programs which are mandatory to the device, such as, in the case of a smartphone, communications applications and the like. These would typically be the applications which are bundled with the smartphone by the device manufacturer when the phone is first sold. Further applications which are added to the smartphone by the user would usually be stored in the user memory 110.

On any computing device, such as the smartphone 10 shown in FIG. 3, data processing operations can be broken down into components as discussed above in relation to FIG. 2. For the sake of clarity in the following discussion, various definitions will now be provided to explain terms used in describing some example embodiments.

In an example embodiment, a component is an atomic entity in a data processing system, as in the OpenMax IL definition given above. Examples are data sources, data sinks, codecs, and processing effects. Components are generally for performing data manipulation operations, including but not limited to such operations as fetching data from a storage location, or encoding data according to a particular codec.

A stream is a chain of components, collected together in a specified order to represent a particular data processing operation required by an application use case. An examplary stream is shown in FIG. 2, which represents the use case of retrieving data from a storage location 1 and transforming it in order to play it out through a speaker 6.

A stream container is a collection of streams, modelling a complex use case defined by an application. An example is playing out audio and video data simultaneously, for instance from an MP4 file. One stream could be used to model the decoding and playing of the audio track, and a separate stream could be used to model the decoding and playing of the video track.

Components, streams and stream containers are constructs used in the multimedia architecture of the Symbian® operating system. Another term used in this context is “graph”. A graph is a representation of any group of components, streams or stream containers, optionally including information defining the different elements in the graph, and/or detailing the relationships between the elements. Examples of such relationships are master-slave, sender-receiver, and client-provider. It will be understood by the person skilled in the art that, although the following detailed description is given in the context of the Symbian® operating system, the general concepts of the invention are applicable to any computing environment.

In the context of this invention, the term “message” is used to refer to any signal or instruction, passed between software or hardware elements of a computing device, which relates to a data processing operation. A message is generally an indication that a particular operation is required by a process or application running on the device, or an indication of details of a data processing operation, or a notification relating to a data processing operation. A “dispatching entity” is an entity in a computing device which receives messages indicating that certain data processing operations are required, and passes the messages on to appropriate elements of the device to enable the data processing operations to take place. The messages are sent initially from the requesting client process. (The term “client” is used here not necessarily in the sense of a client-server architecture, but more generally in the sense of an application requiring a service from another entity in the computing device.)

An embodiment of the invention will now be described with reference to FIG. 4, in which a dispatching entity 40 is arranged to receive messages originating from client processes or applications within a computing device indicating that a data processing operation is requested. In this embodiment the dispatching entity is created by the multimedia subsystem within the device, and it is arranged to handle multimedia-related messages.

The dispatching entity 40 represents a generic entity, which may itself be considered as a stream container, a stream or a container. It responds to the receipt of a message by seeking input on how to handle the message. Specifically, in this embodiment, the dispatching entity queries a data structure of predefined dispatching schemes to determine how to handle the message. The data structure is referred to in an example embodiment as a decision engine, and it may be implemented for example as a database. In an example embodiment, a dispatching scheme is effectively a set of instructions defining what is required in order to carry out the data processing operation indicated in a given message. For example, a “play audio” message might create a stream as shown in FIG. 2, to include the following components:

data source

codec

data sink.

In this embodiment, the group of components together with its order (i.e. a stream) would be indicated in a dispatching scheme associated with an audio play request. In addition, timing considerations could be included in the dispatching scheme, to take account of such factors as the inherent latency of hardware or software entities. The dispatching scheme could also specify the sequence in which the components should optimally be created, initialised and commanded to execute an operation, based on knowledge of the components and their dependencies. For example, if one component defines a buffer within shared memory, and a second component uses the definition of that buffer, then the first component defining the buffer should be created before the second component using the buffer. Such relationships are defined within the dispatching scheme to for proper coordination of the components. The predefinition of dispatching schemes could be automated, or partly automated, such that a set of rules is used to construct dispatching schemes for given events. Alternatively, or in addition, dispatching schemes could be manually written by a programmer having knowledge of the computing environment in which the schemes are to be applied.

In the above-described embodiment, each dispatching scheme in the decision engine is associated with one or more messages. In this way, when a dispatching entity receives a message, it can query the decision engine for the dispatching scheme corresponding to that message. In response to obtaining the appropriate dispatching scheme (or one of the appropriate dispatching schemes, if there is more than one), the dispatching entity creates the specified entities for handling the data processing operation identified in the message. In the example shown in FIG. 4, a message has been received which requires components A, B and C (45) to be constructed. The order of construction of the components may be specified in the relevant dispatching scheme if any timing issues could impact the time taken to create the three components. For example, if component B is known to take a long time to be created then it may make sense to create component B first so that its creation is running in the background while other components are being created. In a similar way, timing considerations are taken into account when the dispatching entity causes each component to initialise.

After initialisation, the components in this embodiment (shown as 45 in FIG. 4) are able to receive and execute control commands from the dispatching entity. FIG. 4 shows a control command X (41), which relates to the execution of a particular data processing operation specified in a message. The command includes details of the data to be operated on, and/or the location of the data in memory, as well as the processing operation to be performed.

Having queried the decision engine and created and initialised the components A-C, the dispatching entity 40 has obtained information 43 from the database regarding the order and timing according to which the components should be commanded to execute their respective data processing tasks. The timing could be influenced by the length of time expected to be taken by each component to perform its task. For example, one component could represent a hardware chip that is known to take a certain length of time to respond. In that case, there would be no point in commanding the next component in the sequence to perform its task until the chip had had time to respond, so a delay time could be built into the dispatching entity's commands to the various components.

A propagation scheme 43 is retrieved by the dispatching entity from the decision engine to indicate the order in which the control command is propagated to the components A-C. This order is represented by the dashed lines shown as X1-X3 in FIG. 4. The commands X1-X3 may cause the respective component to change its state, e.g. from idle to active, where in the active state the component performs the relevant operation. On receiving the command, each component A-C in the embodiment will perform its own specific task, so that when a command has been propagated to all relevant components, and all relevant components have acted on their commands, the overall processing operation is completed. In a similar way, the solid lines Y1-Y3 indicate the order in which the dispatching entity instructs the components A-C to perform tasks in response to the control command Y (42), having queried the database and retrieved a propagation scheme (44) associated with control command Y.

In the embodiment, messages that are known to be likely to occur in the computing device of FIG. 4 are associated with a corresponding dispatching scheme in the decision engine. However, it is not necessary that all possible messages should map on to a predefined dispatching entity within the decision engine; instead, dispatching entities can be generated dynamically, in response to receipt of a message at the dispatching entity. Rules could be predefined to determine how messages are handled by the dispatching entity, for example to ensure that where multiple components having different timing characteristics are used for the performance of a particular task, a predefined timing relationship between the components will be respected in order to avoid unnecessary delays, or to ensure that where a certain function is required (say, encoding or decoding of a stream of data in accordance with a particular codec), a predefined component will be utilised to carry out that function. These rules could be queried whenever a message is received at the dispatching entity for which the database does not contain a predefined dispatching scheme specifying how that message should be handled.

Such dynamic handling of messages where no dispatching entity has been predefined may allow significant flexibility in the functionality that may be implemented by a computing device, because new rules can be added whenever new hardware or software functionality becomes available to the computing device.

In the embodiment described above in relation to FIG. 4, a stream consisting of three components (A-C) is created by means of the dispatching entity, and utilised for performing the tasks identified in the two commands X and Y. The commands are functionally related to each other, hence their use of the same components. Command X could represent, say, a play operation relating to a music track, while command Y represents a pause operation. It should be noted that in more complex data processing scenarios, a stream container may be appropriate, enabling the creation of multiple streams. In general, the larger entities will be created before the smaller entities. Thus, a stream container would generally be created first, and then the streams that it contains, and then the components making up the streams. More complex scenarios such as this may necessitate more than one dispatching scheme being retrieved from the decision engine of dispatching schemes, or a combination of predefined dispatching schemes and dynamically created schemes being used.

A summary of the process of the example embodiment of FIG. 4 is shown in FIG. 5. At block 50, a message is received at the dispatching entity. Data is then retrieved which specifies how the message is to be handled (block 51). At block 52, various messages are sent from the dispatching entity to selected components, and at block 53 the components perform the data processing operation, in accordance with the messages sent from the dispatching entity.

Considerable flexibility may be achieved in a computing device by providing for messages to be handled at runtime, as described in relation to the example embodiments. In addition to the advantage previously mentioned, that new functionality can be incorporated into the handling of messages, it is also possible to provide rules that cause predefined dispatching schemes to be overridden at runtime. The overridden schemes may be replaced with new, defined dispatching schemes, or they may be replaced with a set of further rules to be followed at runtime to enable a dispatching scheme to be created dynamically, in response to the conditions within the computing device. Thus, for example, a low battery condition could be detected, causing a default dispatching scheme for a particular operation to be overridden by an alternative handling procedure that takes into account the reduced power available to the computing device. In general, by providing a dispatching entity for receiving and propagating messages relating to multiple different processing operations, numerous possibilities are introduced for how the messages may be handled at runtime. Unexpected use cases can be handled by the use of predefined rules for determining how to process certain types of requests. Also, by providing the dispatching schemes and/or rules for handling messages in an entity (such as a database) externally to the dispatching entity, additions or changes to the message handling procedures can be made relatively easily, without rewriting of the dispatching entity.

A further advantage of embodiments of the invention is that they can provide a convenient mechanism for error handling. If a component encounters an error in carrying out any task allocated to it, it can notify the dispatching entity of the error. The dispatching entity can then take appropriate action, which may include broadcasting the error to other components in a stream, escalating the error to a stream container, escalating the error to management software in the computing device, and/or notifying the client process.

Embodiments of the invention may avoid some disadvantages of hardcoding solutions for particular data processing use cases, such that they can be inflexible and cannot reliably be used to handle previously unknown or unforeseen use cases. For example, if a set of predefined solutions were written in isolation from the hardware on which they were ultimately to be used, then those solutions may not make use of the full capabilities of the available hardware. If a generic set of predefined solutions were written, say, to run on a series of different mobile phone hardware platforms, then a high-specification mobile phone having, say, a bass booster for high-quality audio playout, may not be used to its maximum possible extent because the generic solutions do not assume the presence of a bass booster. Likewise, if an upgrade is made to the hardware or software resident on a computing device after the device has been built, then the predefined data processing solutions may not be able to make full use of the upgraded capabilities of the device since they were written to be implemented on a device that did not have that upgraded functionality. Furthermore, a set of solutions must generally be specific to the hardware platform on which the data processing operations are to be run. Therefore it may not be possible to port the solutions to another hardware platform without substantially rewriting the solutions to accommodate the particular items of hardware (such as, for example, a different processor or a different speaker).

A further disadvantage of hardcoding solutions for data processing use cases is that the hardcoded programs must be permanently stored on the computing device thereby consuming valuable memory capacity and potentially slowing down the device due to pre-emptive loading of the solutions in situations where they may be required. For example, when an audio player application is launched on a mobile phone, the data processing solutions relevant to audio playout may be loaded together with the application so that they are immediately available when needed, and this could increase the time taken for the application to launch.

Embodiments of the invention may be implemented in software, in hardware, or in a combination of software and hardware.

It will be understood by the skilled person that alternative implementations are possible, and that various modifications of the methods and implementations described above may be made within the scope of the invention, as defined by the appended claims.

1. A method for handling messages relating to data processing operations in a computing device, the method comprising:
receiving a message from a client process at a dispatching entity;
in response to receiving the message, retrieving, from an entity external to the dispatching entity, data specifying how the message is to be handled; and
in response to retrieving the data, causing one or more selected components of the computing device to carry out a data processing operation indicated in the message, by sending further messages from the dispatching entity to the said components.

2. A method according to claim 1 wherein the retrieval of data specifying how the message is to be handled is performed at runtime, such that a determination of how the message is to be handled is made dynamically in response to receiving the message at the dispatching entity.

3. A method according to claim 1 wherein the retrieval of data comprises retrieving a predefined scheme from a data structure, the scheme corresponding to the message received at the dispatching entity.

4. A method according to claim 3 wherein the scheme specifies which components are to be used in the handling of the message.

5. A method according to claim 4 wherein the scheme additionally specifies timing considerations relating to the components that are to be used in the handling of the message, such as the order in which the further messages are to be sent from the dispatching entity to the components.

6. A method according to claim 5 wherein the timing considerations are based at least in part on hardware or software dependencies between the said components.

7. A method according to claim 5 wherein the timing considerations are based at least in part on conditions prevailing within the computing device.

8. A method according to claim 1 wherein no predefined scheme exists which corresponds to the message received at the dispatching entity, and the retrieval of data comprises retrieving one or more rules, at least one rule corresponding to more than one message and specifying how a given type of message is to be handled.

9. A dispatching entity for handling messages relating to data processing operations in a computing device, the dispatching entity being arranged to perform:
receiving a message from a client process at a dispatching entity;
in response to receiving the message, retrieving, from an entity external to the dispatching entity, data specifying how the message is to be handled; and
in response to retrieving the data, causing one or more selected components of the computing device to carry out a data processing operation indicated in the message, by sending further messages from the dispatching entity to the said components.

10. Apparatus according to claim 9 wherein the at least one memory and the computer program code are configured to, with the at least one processor, cause the apparatus to additionally perform the retrieval of data, specifying how the message is to be handled, at runtime, such that a determination of how the message is to be handled is made dynamically in response to receiving the message at the dispatching entity.

11. (canceled)

12. (canceled)

13. Apparatus according to claim 9 wherein the retrieval of data comprises retrieving a predefined scheme from a data structure, the scheme corresponding to the message received at the dispatching entity.

14. Apparatus according to claim 13 wherein the scheme specifies which components are to be used in the handling of the message.

15. Apparatus according to claim 14 wherein the scheme additionally specifies timing considerations relating to the components that are to be used in the handling of the message, such as the order in which the further messages are to be sent from the dispatching entity to the components.

16. Apparatus according to claim 15 wherein the timing considerations are based at least in part on hardware or software dependencies between the said components.

17. Apparatus according to claim 15 wherein the timing considerations are based at least in part on conditions prevailing within the computing device.

18. Apparatus according to claim 9 wherein no predefined scheme exists which corresponds to the message received at the dispatching entity, and the retrieval of data comprises retrieving one or more rules, at least one rule corresponding to more than one message and specifying how a given type of message is to be handled.

19. A computer program product comprising computer program code arranged to perform:
receiving a message from a client process at a dispatching entity;
in response to receiving the message, retrieving, from an entity external to the dispatching entity, data specifying how the message is to be handled; and
in response to retrieving the data, causing one or more selected components of the computing device to carry out a data processing operation indicated in the message, by sending further messages from the dispatching entity to the said components.
